(19) United States
(12) Patent Application Publication
(10) Pub. No.: US 2009/0200007 A1
(43) Pub. Date: Aug. 13, 2009

(54) HEAT EXCHANGER HAVING TEMPERATURE-ACTUATED VALVES

(75) Inventors: Brian W. Foy, Apalachin, NY (US); George H. Thiel, Endicott, NY (US)

Correspondence Address: MICHAEL BEST & FRIEDRICH LLP, 100 E WISCONSIN AVENUE, Suite 3300, MILWAUKEE, WI, 53202, US

(73) Assignee: LOCKHEED MARTIN CORPORATION, Bethesda, MD (US)

(21) Appl. No.: 12/030,308

(22) Filed: Feb. 13, 2008

(51) Int. Cl. G05D 23/00; F28D 15/00

(52) U.S. Cl. 165/287; 165/104.33

(57) ABSTRACT

A heat exchanger includes a body having a plurality of cooling fins defining a plurality of channels therebetween. The heat exchanger also includes a valve positioned in a first channel of the plurality of channels. At least a portion of the valve includes a shape memory material having a thermal transformation temperature. The valve is movable between a first discrete position and a second discrete position. Fluid flow is allowed through the first channel when the valve is in the first discrete position above the thermal transformation temperature. Fluid flow is at least partially blocked in the first channel when the valve is in the second discrete position below the thermal transformation temperature.

### FIELD OF THE INVENTION

The present invention relates to heat exchangers, and more particularly to cold plates for cooling electronics.

### BACKGROUND OF THE INVENTION

Heat exchangers, or “cold plates,” are typically used to cool electrical components, such as microprocessors and other integrated circuits. Such cold plates are typically in thermal contact with the integrated circuit to allow heat from the microprocessors and other heat-generating components in the integrated circuit to dissipate into the cold plate. Cold plates may be air-cooled or liquid-cooled.

### SUMMARY OF THE INVENTION

To effectuate quick and efficient redistribution of coolant within a heat exchanger, the present invention provides a valve that is quickly movable from a first discrete position to a second discrete position upon reaching a thermal transformation temperature. By incorporating several of such valves into a heat exchanger, coolant can be quickly redirected throughout the heat exchanger in response to rapidly-changing heat-dissipation demands of heat-generating electrical or electronic components (e.g., microprocessors, etc.) at different locations relative to the heat exchanger, thereby minimizing the lag in the responsiveness of the valve to the heat-generating component.

The present invention provides, in one aspect, a heat exchanger including a body having a plurality of cooling fins defining a plurality of channels therebetween. The heat exchanger also includes a valve positioned in a first channel of the plurality of channels. At least a portion of the valve includes a shape memory material having a thermal transformation temperature. The valve is movable between a first discrete position and a second discrete position. Fluid flow is allowed through the first channel when the valve is in the first discrete position above the thermal transformation temperature. Fluid flow is at least partially blocked in the first channel when the valve is in the second discrete position below the thermal transformation temperature.

The present invention provides, in another aspect, a heat exchanger including a body having a plurality of cooling fins defining a plurality of channels therebetween. The heat exchanger also includes a valve positioned in a first channel of the plurality of channels. The valve is movable between a first position, in which fluid flow is allowed through the first channel, and a second position, in which fluid flow is at least partially blocked in the first channel. At least a portion of the valve includes a shape memory alloy having an austenitic crystal structure when in the first position and a martensitic crystal structure when in the second position.

The present invention provides, in yet another aspect, a heat exchanger including a body having a plurality of cooling fins defining a plurality of channels therebetween. The heat exchanger also includes a valve positioned in a first channel of the plurality of channels. The valve is movable between a first position, in which fluid flow is allowed through the first channel, and a second position, in which fluid flow is at least partially blocked in the first channel. At least a portion of the valve includes a shape memory polymer comprising a cross-linked block copolymer.

Other features and aspects of the invention will become apparent by consideration of the following detailed description and accompanying drawings.

### BRIEF DESCRIPTION OF THE DRAWINGS

FIG. 1 is a perspective view of a heat exchanger of the present invention adjacent to a substrate having an electronic component.

FIG. 2 is an exploded, cross-sectional perspective view of the heat exchanger of FIG. 1, illustrating a plurality of valves.

FIG. 3 is a top view of a portion of the heat exchanger of FIG. 1, illustrating a plurality of electronic components underlying the heat exchanger.

FIG. 4 is a cross-sectional view of the heat exchanger of FIG. 1, illustrating one of the valves in an open configuration.

FIG. 5 is a cross-sectional view of the heat exchanger of FIG. 1, illustrating one of the valves in a closed configuration.

FIG. 6 is a cross-sectional view of an alternative construction of the heat exchanger of FIG. 1, illustrating one of a plurality of valves in an open configuration.

FIG. 7 is a cross-sectional view of the heat exchanger of FIG. 6, illustrating one of a plurality of valves in a closed configuration.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

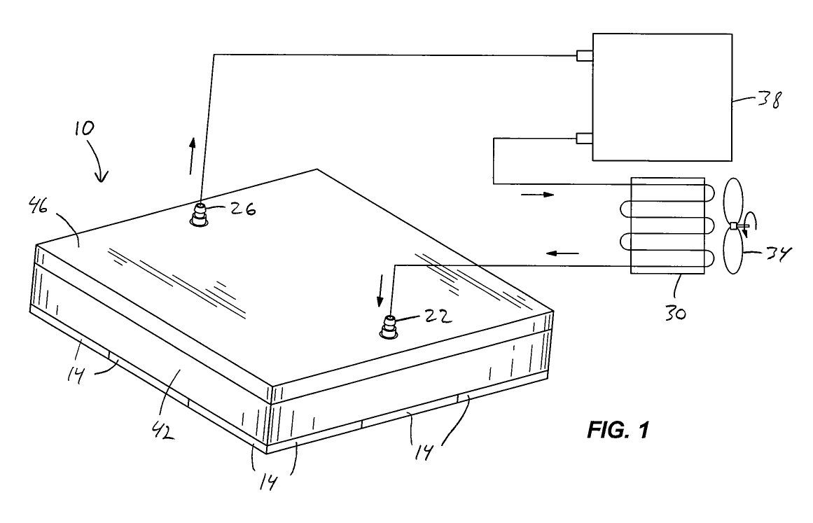

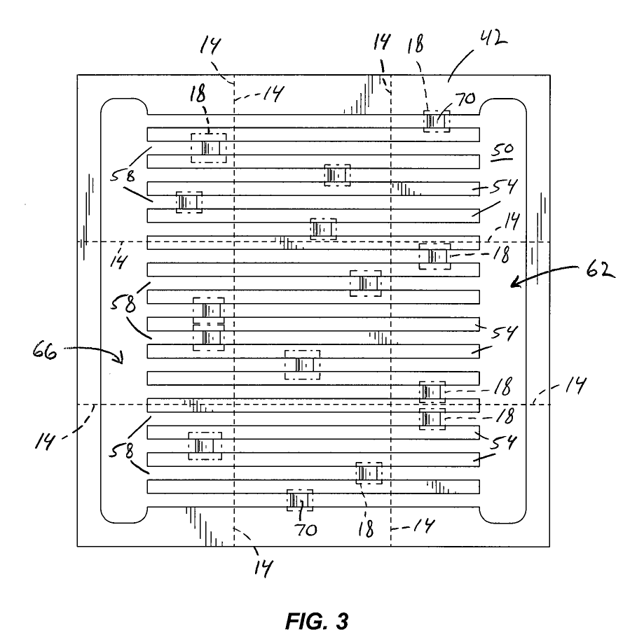

With reference to FIG. 1, a heat exchanger 10 is coupled or disposed adjacent to a substrate, such as a printed wiring board, having one or more subcircuits 14. The heat exchanger 10 is operable to cool heat-generating components 18 in the subcircuits 14 (see also FIG. 3). Such components 18 may include, for example, microprocessors, capacitors, resistors, diodes, multiplexers, memory devices, amplifiers, switches, or other discrete or integrated devices. With reference to FIG. 1, the heat exchanger 10 includes an inlet 22 through which a chilled coolant is introduced to the heat exchanger 10 and an outlet 26 through which the heated coolant is discharged from the heat exchanger 10. Another heat exchanger 30 may be utilized to cool or chill the heated coolant discharged from the heat exchanger 10. A fan 34 or other air-moving device may also be utilized to increase the efficiency of the heat exchanger 30. A pump 38 is utilized to circulate coolant through the heat exchangers 10, 30. The heat exchanger 10 may be utilized with any of a number of different coolants (e.g., de-ionized water, ethylene glycol, air, etc.).

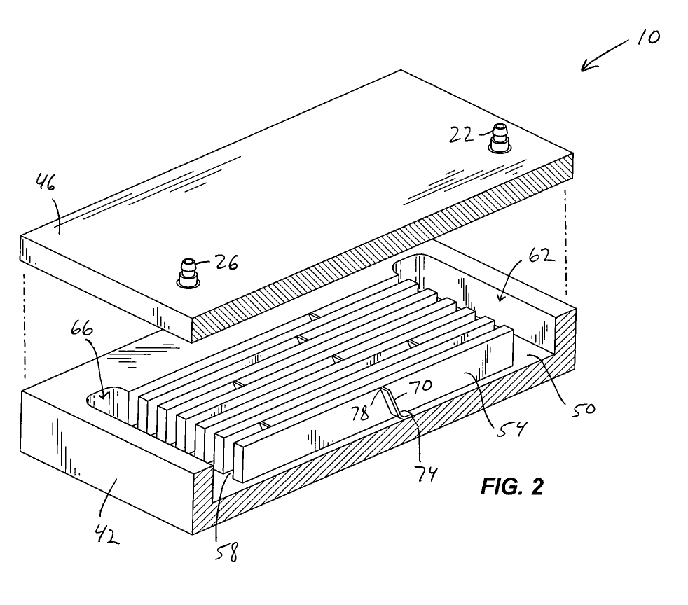

With reference to FIG. 2, the heat exchanger 10 includes a body 42 and a cover 46 coupled to the body 42. Although not shown in FIGS. 1 or 2, the cover 46 may be coupled to the body 42 using conventional fasteners (e.g., screws, bolts, etc.), a welding or soldering process, or any of a number of different coupling devices or joining processes. With reference to FIG. 2, the body 42 includes a lower surface 50 and a plurality of substantially parallel cooling fins 54 extending from the lower surface 50. A channel 58 is defined between each pair of adjacent cooling fins 54. The body 42 also includes an inlet plenum 62 partially defined by the lower surface 50, and an outlet plenum 66 partially defined by the lower surface 50. Each of the channels 58 opens into and is in fluid communication with the inlet plenum 62 and the outlet plenum 66. As such, each of the channels 58 is in fluid communication with one another through the plenums 62, 66. The inlet 22 is positioned above the inlet plenum 62 such that coolant introduced into the heat exchanger 10 accumulates in the inlet plenum 62. Likewise, the outlet 26 is positioned above the outlet plenum 66 such that coolant about to exit the heat exchanger 10 accumulates in the outlet plenum 66. In an alternative construction of the heat exchanger 10, the inlet and outlet plenums 62, 66 may be omitted, and a plurality of apertures through the cooling fins 54 may be utilized to fluidly communicate the two adjacent channels 58 with one another.

With continued reference to FIG. 2, the heat exchanger 10 includes a plurality of valves 70 positioned in the channels 58. In the illustrated construction, a valve 70 is positioned in each channel 58 at a location corresponding to the position of the heat-generating components 18 in the subcircuits 14 (see also FIG. 3). In an alternative construction of the heat exchanger 10, the body 42 may not include cooling fins 54 or channels 58 over portions of the subcircuits 14 not having heat-generating components 18, or portions of the subcircuits 14 that generate little heat. In another alternative construction of the heat exchanger 10, one or more of the channels 58 in the body 42 may omit the valve 70 to allow unrestricted coolant flow irrespective of the cooling capacity required in that channel 58. In yet another alternative construction of the heat exchanger 10, more than one valve 70 may be positioned in a single channel 58 in the heat exchanger 10.

With reference to FIG. 2, each of the valves 70 is configured as a rectangular plate having a first end 74 coupled to the lower surface 50 of the body 42 and a second, free end 78. The portion of the valve 70 proximate the first end 74 may be coupled to the lower surface 50 of the body 42 using conventional fasteners (e.g., screws, bolts, etc.), a welding or soldering process, or any of a number of different coupling devices or joining processes. Alternatively, the valves 70 may be differently configured depending upon the shape and configuration of the channels 58.

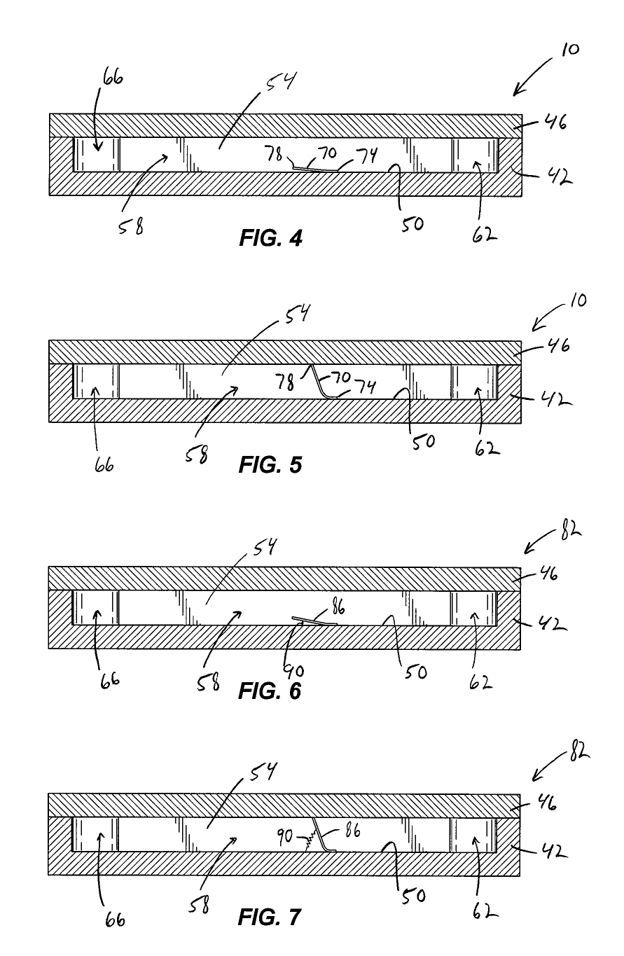

With reference to FIGS. 2, 4, and 5, each of the valves 70 includes a shape memory material having a thermal transformation temperature above which the valve 70 moves or switches to a discrete, open position or configuration (see FIG. 4) to allow increased or substantially undisrupted flow of coolant through its associated channel 58, and below which the valve moves or switches to a discrete, closed position or configuration (see FIG. 5) to substantially reduce or block the flow of coolant through its associated channel 58. As such, each of the valves 70 may be “programmed” or designed to open or close at a desired temperature by selecting the composition of the shape memory material so that the thermal transformation temperature substantially corresponds to the desired opening and closing temperatures for each of the valves 70. Localized temperature control and cooling capacity can therefore be achieved in each channel 58 to respond to localized “hot spots” in the body 42.

For example, a channel 58 positioned over a heat-generating component 18 that is configured to operate at a relatively high temperature (e.g., for example, 120 degrees Celsius) may include a valve 70 having a shape memory material with a higher thermal transformation temperature to allow the valve 70 to open at a higher temperature to cool the component 18 and stabilize its operating temperature at about 120 degrees Celsius. Likewise, a channel 58 positioned over a heat-generating component 18 that is configured to operate at a relatively low temperature (e.g., for example, 80 degrees Celsius) may include a valve 70 having a shape memory material with a lower thermal transformation temperature to allow the valve 70 to open at a lower temperature to cool the component 18 and stabilize its operating temperature at about 80 degrees Celsius.

With reference to FIGS. 4 and 5, each of the valves 70 is comprised entirely of a shape memory material. Alternatively, only a movable portion of each of the valves 70 including the second end 78 may include the shape memory alloy. In other words, with reference to FIG. 5, only the portion of the valve 70 immediately adjacent the portion of the valve 70 attached to the lower surface 50 of the body 42 needs to include a shape memory material to cause the valve 70 to actuate or switch between the open configuration shown in FIG. 4 and the closed configuration shown in FIG. 5.

As shown in FIGS. 4 and 5, each of the valves 70 includes a shape memory material programmed to exhibit a two-way shape memory effect, in which each of the valves 70 assumes a first programmed shape or configuration at a temperature above its thermal transformation temperature, and in which each of the valves 70 assumes a second programmed shape or configuration at a temperature below its thermal transformation temperature, without the application of an external force on the valve 70. In the illustrated construction, the first programmed shape or configuration of the valve 70 is the “open” or substantially flat configuration shown in FIG. 4. As described in more detail below, when the portion of the body 42 between the valve 70 and a heat-generating component 18 in one of the subcircuits 14 reaches a localized temperature above the thermal transformation temperature of the valve 70, the valve 70 switches from its substantially deformed, “closed” configuration shown in FIG. 5 to the open configuration shown in FIG. 4. Likewise, the second programmed shape or configuration of the valve 70 is the closed configuration shown in FIG. 5. As described in more detail below, when the same portion of the body 42 between the valve 70 and the heat-generating component 18 is cooled to a localized temperature below the thermal transformation temperature of the valve 70, the valve 70 switches from its open configuration shown in FIG. 4 to the closed configuration shown in FIG. 5.

The shape memory material utilized in the valves 70 may include a shape memory alloy, such as, for example, a nickel-titanium alloy (otherwise known as “Nitinol”) available from Memry Corporation of Bethel, Conn. As is understood by those of ordinary skill in the art, the phase transformation in Nitinol shape memory alloys from a martensitic crystal structure to an austenitic crystal structure upon heating the alloy to a temperature greater than its thermal transformation temperature is the basis for the above-described operation of the valves 70 in the heat exchanger 10. At a temperature below its thermal transformation temperature, the crystal structure of the shape memory alloy is comprised of martensite. When comprised of martensite, the shape memory alloy, if strained or deformed by an external force, will remain in its deformed shape upon removal of the external force that caused the deformation. However, at a temperature above its thermal transformation temperature, the crystal structure of the shape memory alloy is comprised of austenite. When comprised of austenite, the shape memory alloy, if previously deformed from its original shape, will recover substantially all of the strain from its deformation to return to its original shape. At a temperature above the thermal transformation temperature of the shape memory alloy, the alloy is “superelastic,” or otherwise able to return to its original shape after experiencing a large amount of strain from the application of an external force. Some shape memory alloys, for example, can experience as much as 8 percent recoverable strain without permanently damaging or deforming the alloy.

As is understood by those of ordinary skill in the art, shape memory alloys may be configured to exhibit either a one-way shape memory effect or the aforementioned two-way shape memory effect. In a shape memory alloy configured to exhibit the one-way shape memory effect, an external force is required to again deform or strain the alloy subsequent to a displacive or diffusionless phase transformation from austenite to martensite. However, in a shape memory alloy configured to exhibit the two-way shape memory effect, the alloy is programmed or trained to return to a shape (a “first programmed shape”), subsequent to a phase transformation from martensite to austenite, in which not all of the strain previously imparted to the alloy when comprised of martensite is recovered. The application of such an amount of strain severely and permanently deforms the alloy (i.e., from its original flat shape). Then, subsequent to a phase transformation from austenite back to martensite, the alloy returns to a deformed shape (a “second programmed shape”) somewhere between the first programmed shape and the severely deformed shape during the training or programming process.

With reference to FIGS. 4 and 5, the valve 70 is shown in its first programmed shape and its second programmed shape, respectively. To impart these shapes to each of the valves 70, the programming process involving severely deforming or straining the valves 70, at a temperature below the thermal transition temperature, to a degree such that the second programmed shape is somewhere between the first programmed shape (FIG. 4) and the severely deformed shape. In the illustrated construction, for example, the severely deformed shape of the valve 70 may include the free end 78 of the valve 70 folded over the attached end 74 of the valve 70. Other training processes may exist besides severe deformation of the shape memory alloy at a temperature below the thermal transformation temperature, however.

With reference to FIGS. 6 and 7, an alternative construction of a heat exchanger 82 includes a plurality of valves 86 having a shape memory alloy configured to exhibit the one-way shape memory effect. Like components are labeled with like reference numerals. As such, an external force is required to deform the valve 86 subsequent to a phase transformation from austenite to martensite (corresponding to a decrease in the temperature of the valve 86 to a temperature below the thermal transformation temperature) to move the valve 86 from its open configuration (FIG. 6) to its closed configuration (FIG. 7). A biasing member 90 is positioned between the lower surface 50 of the body 42 and the valve 86 to provide this external force. The biasing member 90 may be configured as a spring, or in any of a number of different resiliently deformable structures to push or pull the valve 86 to its closed configuration shown in FIG. 7.

The shape memory material utilized in the valves 70 of the heat exchanger 10 may also include a shape memory polymer, such as, for example, a cross-linked block copolymer. Polyurethanes and polyether esters are two examples of block copolymers that can be cross-linked to yield the thermally-activated shape memory polymer polyesterurethane. Polyurethane and polyether ester raw materials are available from any of a number of different polymer suppliers (e.g., DuPont, Bayer, etc.). Alternatively, thermoplastics, thermosets, semi-interpenetrating networks, or mixed networks of polymers may be utilized to form shape memory polymers. The polymers can be linear or branched thermoplastic elastomers with side chains or dendritic structural elements. Other suitable polymer components to form a shape memory polymer include, but are not limited to, polyphosphazenes, poly(vinyl alcohols), polyamides, polyester amides, poly(amino acid)s, polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysiloxanes, polyethers, polyether amides, polystyrene, polypropylene, polyvinyl phenol, polyvinylpyrrolidone, chlorinated polybutylene, poly(octadecyl vinyl ether)ethylene vinyl acetate, polyethylene, poly(ethylene oxide)-poly(ethylene terephthalate), polyethylene/nylon (graft copolymer), polycaprolactones-polyamide (block copolymer), poly(caprolactone)dimethacrylate-n-butyl acrylate, poly(norbornyl-polyhedral oligomeric silsesquioxane), polyvinyl chloride, urethane/butadiene copolymers, polyurethane block copolymers, styrene-butadiene-styrene block copolymers, and the like, and combinations comprising at least one of the foregoing polymer components. Examples of suitable polyacrylates include poly(methyl methacrylate), poly(ethyl methacrylate), ply(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate) and poly(octadecyl acrylate).

Shape memory polymers, like shape memory alloys, can be configured to exhibit the two-way shape memory effect described above. Shape memory polymers exhibiting the two-way shape memory effect include at least two polymer components formed by, for example, interpenetrating networks, where the two polymer components are cross-linked but not to each other. A shape memory polymer can be trained to exhibit the two-way shape memory effect by setting the permanent shape of the first polymer component of the valve 70 (i.e., by initially forming the valve 70 in its first programmed shape shown in FIG. 4), deforming the valve 70 into the permanent shape of the second polymer component of the valve 70 (i.e., the second programmed shape shown in FIG. 5), and fixing the permanent shape of the second polymer component of the valve 70 while applying a stress.

During operation of the heat exchanger 10 incorporating the valves 70 with any shape memory material exhibiting the two-way shape memory effect (see FIGS. 4 and 5), the pump 38 circulates coolant through the heat exchanger 30, where it is cooled or chilled. The chilled coolant is then introduced into the inlet 22 of the heat exchanger 10 and accumulated in the plenum 62 below the inlet 22. If a particular heat-generating component 18 has not reached its desired operating temperature (e.g., shortly after turning on or exercising the component 18), the valve 70 assumes its second programmed shape to close the channel 58 above the particular heat-generating component 18 to substantially block the flow of coolant through the channel 58 (see FIG. 5). As a result, the heat-generating component 18 is allowed to reach its desired operating temperature and stabilize at its desired operating temperature more quickly than it otherwise would if the valve 70 were omitted from the channel 58. Furthermore, more of the chilled coolant could be redirected through the channels 58 in the heat exchanger 10 having valves 70 that would be opened at that time (see FIG. 4).

When the valve 70 and the portion of the body 42 between the valve 70 and the particular heat generating component 18 reach a temperature greater than the thermal transformation temperature of the particular valve 70, the valve 70 switches from its second programmed shape (FIG. 5) to its first programmed shape (FIG. 4) to unblock the channel 58 to allow the flow of coolant through the channel 58 to resume. The coolant flow through the particular channel 58 stabilizes the temperature of the particular heat-generating component 18 while it is operating. If the particular heat-generating component 18 ceases operation and cools, with the valve 70 and the portion of the body 42 between the particular component 18 and the valve 70, to a temperature below the thermal transformation temperature, the valve 70 would switch back to its second programmed shape (FIG. 5) to again block the flow of coolant through the channel 58 so the coolant could be redirected to portions of the heat exchanger 10 requiring cooling.

FIGS. 6 and 7 illustrate operation of the heat exchanger 82 incorporating the valves 86 with the shape memory alloy exhibiting the one-way shape memory effect. If a particular heat-generating component 18 has not reached its desired operating temperature (e.g., shortly after activation of the component 18), the valve 86 is biased upwardly and deformed to assume its closed configuration (FIG. 7). Because the valve 86 is at a temperature below its thermal transformation temperature at this time, the valve 86 yields to the external force applied by the biasing member 90 and resiliently deforms to assume the closed configuration.

When the valve 86 and the portion of the body 42 between the valve 86 and the particular heat generating component 18 reaches a temperature greater than the thermal transformation temperature of the valve 86, the phase transformation from martensite to austenite causes the valve 86 to become superelastic, and the strain previously imparted on the valve 86 by the biasing member 90 is substantially recovered by overcoming the external force applied by the biasing member 90. The biasing member 90 yields to allow the valve 86 to substantially return to its original shape or open configuration to unblock the channel 58 to resume the flow of coolant through the channel 58 (see FIG. 6).

Various features of the invention are set forth in the following claims.

What is claimed is:

1. A heat exchanger comprising:
a body including a plurality of cooling fins defining a plurality of channels therebetween; and
a valve positioned in a first channel of the plurality of channels, wherein at least a portion of the valve includes a shape memory material having a thermal transformation temperature, wherein the valve is movable between a first discrete position and a second discrete position, wherein fluid flow is allowed through the first channel when the valve is in the first discrete position above the thermal transformation temperature, and wherein fluid flow is at least partially blocked in the first channel when the valve is in the second discrete position below the thermal transformation temperature.

2. The heat exchanger of claim 1, wherein the valve includes a first end and a second end, wherein the valve is coupled to the body proximate the first end, and wherein the valve has a movable portion that includes the second end.

3. The heat exchanger of claim 2, wherein at least a portion of the movable portion of the valve includes the shape memory material.

4. The heat exchanger of claim 3, wherein the movable portion of the valve is made entirely of the shape memory material.

5. The heat exchanger of claim 1, wherein the body further includes a plenum defined therein, and wherein at least two of the plurality of channels open into and are in fluid communication with the plenum.

6. The heat exchanger of claim 1, further comprising a second valve coupled to the body and positioned in a second channel of the plurality of channels, wherein at least a portion of the second valve includes a shape memory material having a thermal transformation temperature, wherein the second valve in the second channel is in the first discrete position above the thermal transformation temperature, and wherein the second valve in the second channel is in the second discrete position below the thermal transformation temperature.

7. The heat exchanger of claim 6, wherein fluid blocked from passing through the first channel when the first valve is in its second discrete position is diverted to the second channel when the second valve is in its first discrete position.

8. The heat exchanger of claim 1, further comprising a biasing member coupled to the valve, wherein the valve deforms the biasing member upon movement to the first discrete position, and wherein the biasing member deforms the valve to move the valve to the second discrete position.

9. The heat exchanger of claim 1, wherein the shape memory material includes a shape memory alloy having a martensitic crystal structure below the thermal transformation temperature and an austenitic crystal structure above the thermal transformation temperature.

10. The heat exchanger of claim 9, wherein the shape memory alloy includes a nickel-titanium alloy.

11. The heat exchanger of claim 1, wherein the shape memory material includes a shape memory polymer comprised of a cross-linked block copolymer.

12. A heat exchanger comprising:
a body including a plurality of cooling fins defining a plurality of channels therebetween; and
a valve positioned in a first channel of the plurality of channels, wherein the valve is movable between a first position, in which fluid flow is allowed through the first channel, and a second position, in which fluid flow is at least partially blocked in the first channel, and wherein at least a portion of the valve includes a shape memory alloy having an austenitic crystal structure when in the first position and a martensitic crystal structure when in the second position.

13. The heat exchanger of claim 12, wherein the valve includes a first end and a second end, wherein the valve is coupled to the body proximate the first end, and wherein the valve has a movable portion that includes the second end.

14. The heat exchanger of claim 13, wherein at least a portion of the movable portion of the valve includes the shape memory alloy.

15. The heat exchanger of claim 14, wherein the movable portion of the valve is made entirely of the shape memory alloy.

16. The heat exchanger of claim 12, wherein the body further includes a plenum defined therein, and wherein at least two of the plurality of channels open into and are in fluid communication with the plenum.

17. The heat exchanger of claim 12, further comprising a second valve coupled to the body and positioned in a second channel of the plurality of channels, wherein at least a portion of the second valve includes a shape memory alloy having an austenitic crystal structure when in the first position in the second channel and a martensitic crystal structure when in the second position in the second channel.

18. The heat exchanger of claim 17, wherein fluid blocked from passing through the first channel when the first valve is in its second position is diverted to the second channel when the second valve is in its first position.

19. The heat exchanger of claim 12, wherein the shape memory alloy includes a thermal transformation temperature, wherein the valve is in the first position above the thermal transformation temperature, and wherein the valve is in the second position below the thermal transformation temperature.

20. The heat exchanger of claim 12, further comprising a biasing member coupled to the valve, wherein the valve deforms the biasing member upon movement to the first position, and wherein the biasing member deforms the valve to move the valve to the second position.

21. The heat exchanger of claim 20, wherein the shape memory alloy includes a thermal transformation temperature, wherein the biasing member supports the valve in its second position below the thermal transformation temperature, and wherein the valve maintains the biasing member in a resiliently deformed configuration above the thermal transformation temperature when the valve is in its first position.

22. A heat exchanger comprising:
a body including a plurality of cooling fins defining a plurality of channels therebetween; and
a valve positioned in a first channel of the plurality of channels, wherein the valve is movable between a first position, in which fluid flow is allowed through the first channel, and a second position, in which fluid flow is at least partially blocked in the first channel, and wherein at least a portion of the valve includes a shape memory polymer comprising a cross-linked block copolymer.

23. The heat exchanger of claim 22, wherein the valve includes a first end and a second end, wherein the valve is coupled to the body proximate the first end, and wherein the valve has a movable portion that includes the second end.

24. The heat exchanger of claim 23, wherein at least a portion of the movable portion of the valve includes the shape memory polymer.

25. The heat exchanger of claim 22, wherein the body further includes a plenum defined therein, and wherein at least two of the plurality of channels open into and are in fluid communication with the plenum.
